(19) United States
(12) Patent Application Publication
(10) Pub. No.: US 2014/0332560 A1
(43) Pub. Date: Nov. 13, 2014

(54) BEVERAGE DISPENSER FOR PARTIALLY FROZEN BEVERAGES WITH AN IMPROVED DRIVE AND SEALING SYSTEM

(71) Applicant: Grindmaster Corporation, Louisville, KY (US)

(72) Inventors: Richard Leon Sipp, Crestwood, KY (US); Bradley Scott Whitehouse, Pewee Valley, KY (US); Donald Edward Smith, Louisville, KY (US)

(21) Appl. No.: 14/339,707

(22) Filed: Jul. 24, 2014

Related U.S. Application Data
(63) Continuation of application No. 13/223,639, filed on Sep. 1, 2011.
(60) Provisional application No. 61/379,813, filed on Sep. 3, 2010.

(51) Int. Cl. A23G 9/12; A23G 9/22; A23G 9/04

(52) U.S. Cl. CPC A23G 9/12; A23G 9/045; A23G 9/222
USPC 222/146.6

(57) ABSTRACT

A beverage dispenser for partially frozen beverages includes at least one bowl for storing a beverage product, with a freezing cylinder positioned in the bowl and housing an evaporator. The beverage dispenser further includes a cooling system for supplying a cooling medium to the evaporator to cool the beverage product when stored in the bowl. The beverage dispenser further includes a dispenser assembly for dispensing the beverage product from the bowl. Finally, the beverage dispenser includes an auger which rotates about the freezing cylinder, the auger including a first end positioned near a front of the beverage dispenser and a second end positioned near a rear of the beverage dispenser. The auger has a ring gear positioned at its second end, and a drive system that rotates the auger by driving the ring gear.

### CROSS-REFERENCE TO RELATED APPLICATIONS

The present application is a continuation of U.S. patent application Ser. No. 13/223,639 filed on Sep. 1, 2011, which claims priority to U.S. Provisional Patent Application Ser. No. 61/379,813 filed on Sep. 3, 2010, the entire disclosures of which is incorporated herein by reference.

### BACKGROUND OF THE INVENTION

The present invention relates to a beverage dispenser, and, more particularly, to a beverage dispenser for partially frozen beverages with an improved drive and sealing system.

In the food service industry, various machines have been developed to produce, store, and dispense a partially frozen beverage, such as a slush-type beverage. In general, such machines mix water and a flavored component, freeze the mixture, and then dispense a partially frozen beverage product with a slush-like consistency. Such machines are often referred to as “granita” machines.

In general, such a granita machine includes a bowl for storing the beverage product. A freezing cylinder extends through the bowl and houses evaporator coils (of a refrigeration circuit) that cools the beverage product to the desired temperature. The surface of the freezing cylinder is typically metal and is in direct contact with the evaporator coils, resulting in a large and efficient heat exchange surface. Also located within the bowl is an auger which rotates about the freezing cylinder to shave frozen beverage product off of the surface of the freezing cylinder and to circulate the beverage product within the bowl, resulting in the partially frozen or slush-like consistency of the beverage product.

In most prior art constructions, a granita machine includes a drive shaft that extends through the center of the freezing cylinder and is connected to the auger. At the rear of the granita machine, this drive shaft is operably connected to a gear arrangement and motor. For example, as shown in FIG. 1, the drive shaft 10 extends through the freezing cylinder 12, and, at the front end of freezing cylinder 12, the drive shaft 10 is connected to and drives the auger 14. Thus, such a construction requires a shaft seal 16 at the front end of the freezing cylinder 14. This shaft seal 16 is almost continuously submerged in the partially frozen beverage product and can be prone to leakage, allowing the beverage product to seep into the interior of the freezing cylinder 12. Once the partially frozen beverage product, which typically includes high amounts or sugar and is very sticky, gets into the interior of the freezing cylinder 12, it can be virtually impossible to clean it out of the freezing cylinder 12.

Furthermore, the gear arrangements in prior art constructions are often prone to field failures as a result of heat stresses and overload. In many cases, relatively small C-frame motors are coupled to a gear box, which, in the context of a granita machine, often results in overloading conditions and excessive heat issues. Such overloading and excessive heat issues can reduce the life of the gears, lubricants, and bearings. For example, excessive heat reduces the lubrication ability of the lubricant internal to the gear arrangement, thus often leading to premature failure. For another example, overloading adds high levels of stress to the gear arrangements, thus resulting in failure of the gear teeth in the gear arrangement. Lastly, to the extent that there is any leakage of the partially frozen beverage product in the vicinity of the gearing arrangement, such leakage can also lead to wear and premature failure of the gear arrangement.

### SUMMARY OF THE INVENTION

The present invention is a beverage dispenser for partially frozen beverages with an improved drive and sealing system.

In a beverage dispenser made in accordance with the present invention, the beverage dispenser includes one or more bowls. In each bowl, there is a freezing cylinder, and there is a dispenser assembly at the front end of each bowl for dispensing the beverage product. In each bowl, there is also an auger which rotates about each freezing cylinder to shave frozen beverage product off of the surface of the freezing cylinder and to circulate the beverage product within the respective bowls, resulting in the partially frozen or slush-like consistency of the beverage product.

An exemplary auger for use in a beverage dispenser made in accordance with the present invention is preferably a unitary member molded from a thermoplastic material. The auger preferably includes a helical flange (or flight) that is reinforced by first and second longitudinal ribs that extend the length of the auger. At one end, the helical flange terminates in a cylindrical member that defines an internal cavity. The freezing cylinder includes a boss extending from its front surface that is received in the internal cavity defined by the cylindrical member. Thus, once assembled, the position of the auger relative to the freezing cylinder is maintained, in part, by the connection of the cylindrical member of the auger to the boss extending from the front surface of the freezing cylinder; however, the auger is still free to rotate relative to the freezing cylinder.

In each bowl, the auger is driven from the rear, and thus, there is no drive shaft that extends through the freezing cylinder. In this regard, the auger is preferably formed with an integral ring gear at its second end, which, when assembled, is positioned near the rear of the beverage dispenser. The ring gear is engaged by a drive gear, and the drive gear is rotated by a drive system, such as a belt and pulley arrangement.

In an exemplary belt and pulley arrangement, a first pulley is mounted to a common shaft with the drive gear. The first pulley is then operably connected to a second pulley by a first belt. The second pulley is mounted on another shaft with a third pulley, such that the second pulley rotates with the third pulley on the shaft. The third pulley is then operably connected to a fourth pulley by a second belt. The fourth pulley is driven by a motor, which, through the belt and pulley arrangement described above, causes the drive gear to drive the ring gear to rotate the auger.

In such a construction, there is no drive shaft that extends through a freezing cylinder, and therefore, there is no shaft seal in the lower front portion of the dispenser, where it would be continuously submerged in the partially frozen beverage product. Accordingly, the beverage dispenser of the present invention eliminates the attendant problems of leakage at a front shaft seal as is common in prior art constructions.

Furthermore, replacing prior art gear arrangements with belt and pulley arrangements minimizes the problems of heat generation and allows for the use of larger drive motors to better handle the mixing load, while also reducing maintenance and repair costs.

As an additional benefit, cleaning of the components is much easier as compared to prior art constructions as a bowl and associated auger can be readily pulled forward and removed from the dispenser as a complete assembly and taken to a wash area for cleaning.

### DESCRIPTION OF THE DRAWINGS

FIG. 1 is a perspective view of the freezing cylinder, drive shaft, and auger in a prior art construction of a beverage dispenser;

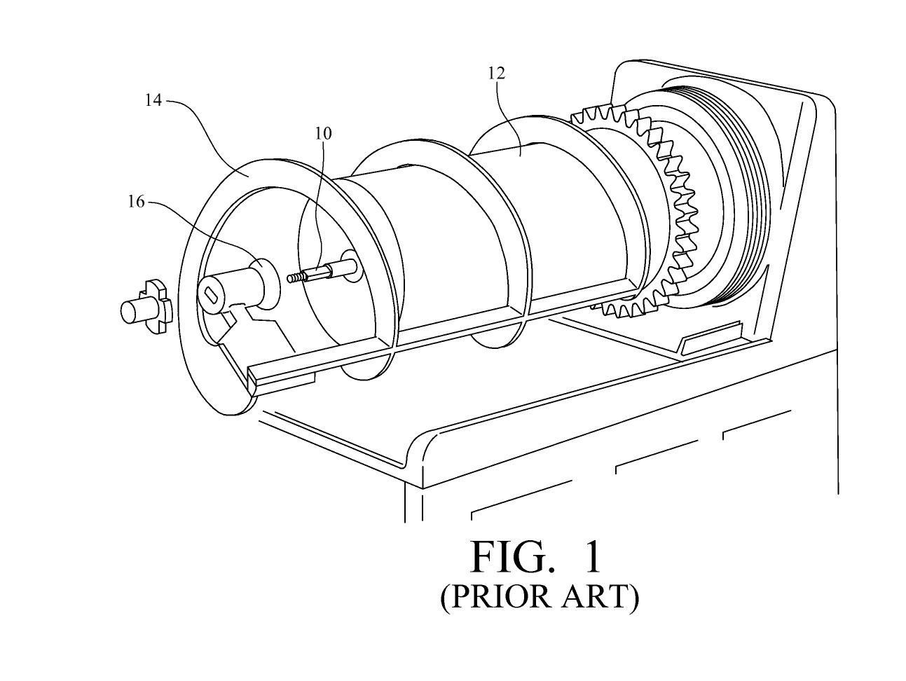

FIG. 2 is a perspective view of an exemplary beverage dispenser made in accordance with the present invention;

FIG. 3 is a perspective view of the exemplary beverage dispenser of FIG. 2, but with one bowl hidden from view to better illustrate the freezing cylinder, auger, and other internal components;

FIG. 4 is an enlarged perspective view of the freezing cylinders, augers, and other internal components of the exemplary beverage dispenser of FIG. 2;

FIG. 5 is an enlarged side view of the exemplary beverage dispenser of FIG. 2, illustrating various components of the drive system;

FIG. 6 is a perspective view of one of the augers of the exemplary beverage dispenser of FIG. 2;

FIG. 7 is a perspective view of one of the freezing cylinders of the exemplary beverage dispenser of FIG. 2;

FIG. 8 is a rear view of the exemplary beverage dispenser of FIG. 2, also illustrating various components of the drive system; and

FIG. 9 is a schematic view of the cooling system in the exemplary beverage dispenser of FIG. 2.

### DETAILED DESCRIPTION OF THE INVENTION

The present invention is a beverage dispenser for partially frozen beverages with an improved drive and sealing system.

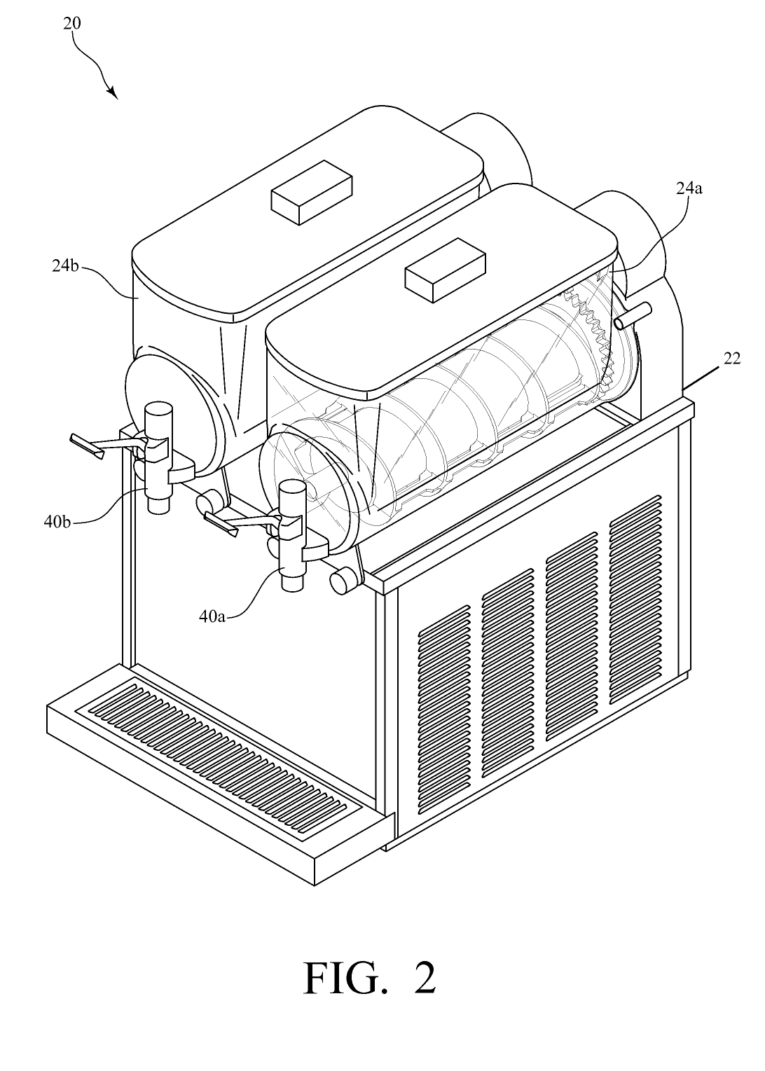

FIG. 2 is a perspective view of an exemplary beverage dispenser made in accordance with the present invention. The exemplary beverage dispenser 20 has two separate bowls 24a, 24b. However, it should be recognized that a beverage dispenser made in accordance with the present invention could have any number of bowls without departing from the spirit and scope of the present invention.

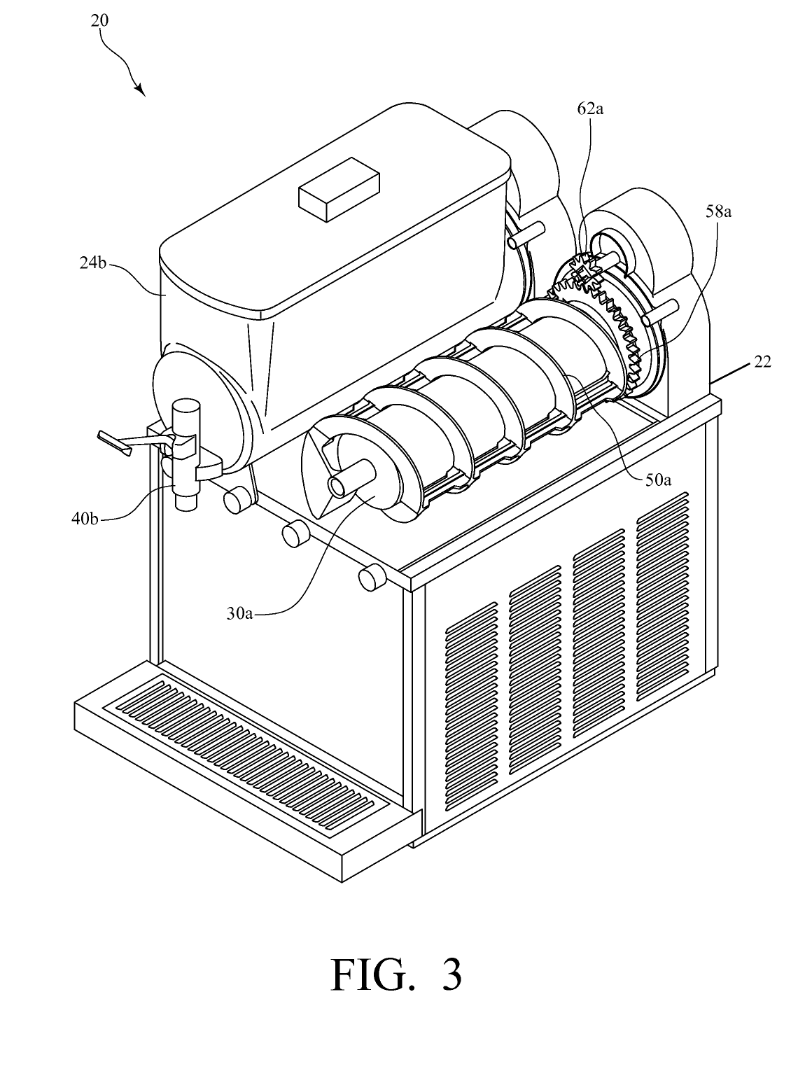

FIG. 3 is a perspective view of the same exemplary beverage dispenser 20, but with one bowl 24a hidden from view to better illustrate some of the internal components of the exemplary beverage dispenser 20.

As shown in FIGS. 2 and 3, in this exemplary beverage dispenser 20, in each bowl 24a, 24b, there is a freezing cylinder 30a, 30b, which, as mentioned above, is typical of prior art constructions. Each freezing cylinder is mounted to and extends from a base 22 of the dispenser 20. Furthermore, there is a dispenser assembly 40a, 40b at the front end of each bowl 24a, 24b for dispensing the beverage product. As is also typical in prior art constructions, in each bowl 24a, 24b, there is an auger 50a, 50b which rotates about the respective freezing cylinder 30a, 30b to shave frozen beverage product off of the surface of the freezing cylinder 30a, 30b and to circulate the beverage product within the respective bowls 24a, 24b, resulting in the partially frozen or slush-like consistency of the beverage product.

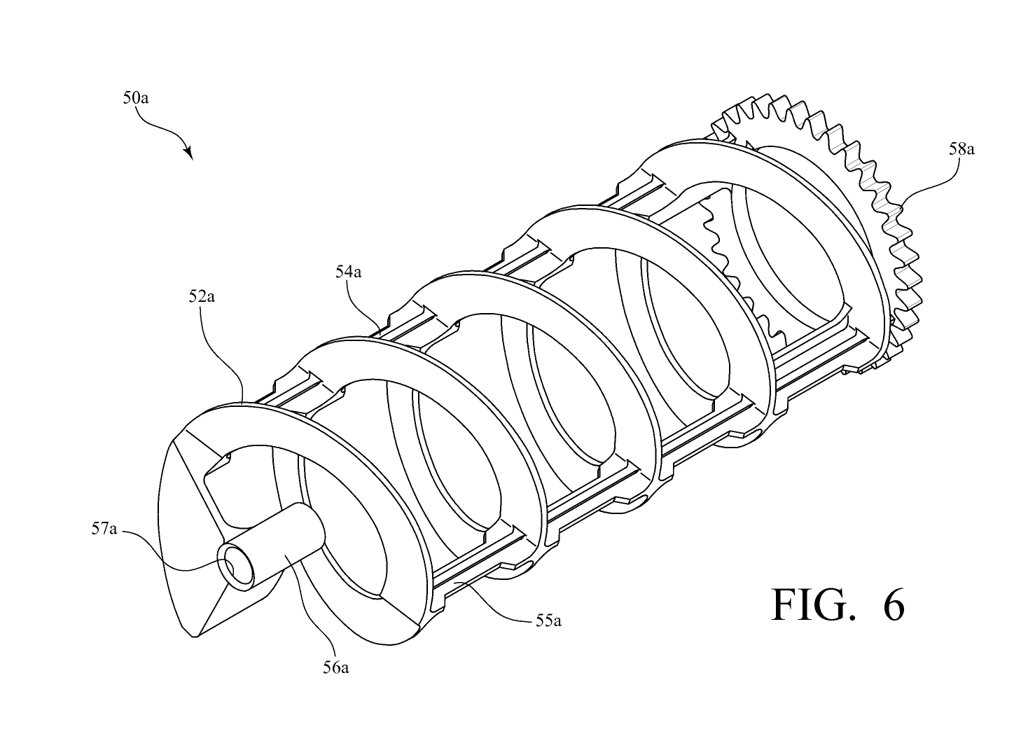

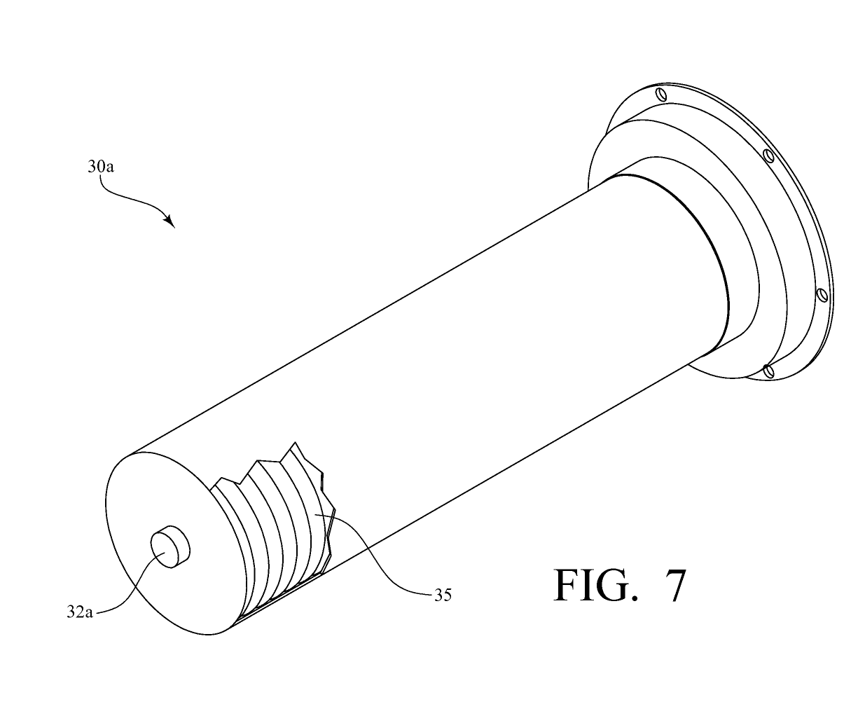

FIG. 6 is a perspective view of one of the augers 50a of the exemplary beverage dispenser 20, and FIG. 7 is a perspective view of one of the freezing cylinders 30a of the exemplary beverage dispenser 20. As shown in FIG. 6, the auger 50a is preferably a unitary member and molded from a thermoplastic material. The auger 50a includes a helical flange (or flight) 52a that is reinforced by first and second longitudinal ribs 54a, 55a that extend the length of the auger 50a. At one end, the helical flange 52a terminates in a cylindrical member 56a that defines an internal cavity 57a. As shown in FIG. 7, the freezing cylinder 30a includes a boss 32a extending from its front surface that is received in the internal cavity 57a defined by the cylindrical member 56a. Thus, once assembled, the position of the auger 50a relative to the freezing cylinder 30a is maintained, in part, by the connection of the cylindrical member 56a of the auger 50a to the boss 32a extending from the front surface of the freezing cylinder 30a; however, the auger 50a is still free to rotate relative to the freezing cylinder 30a.

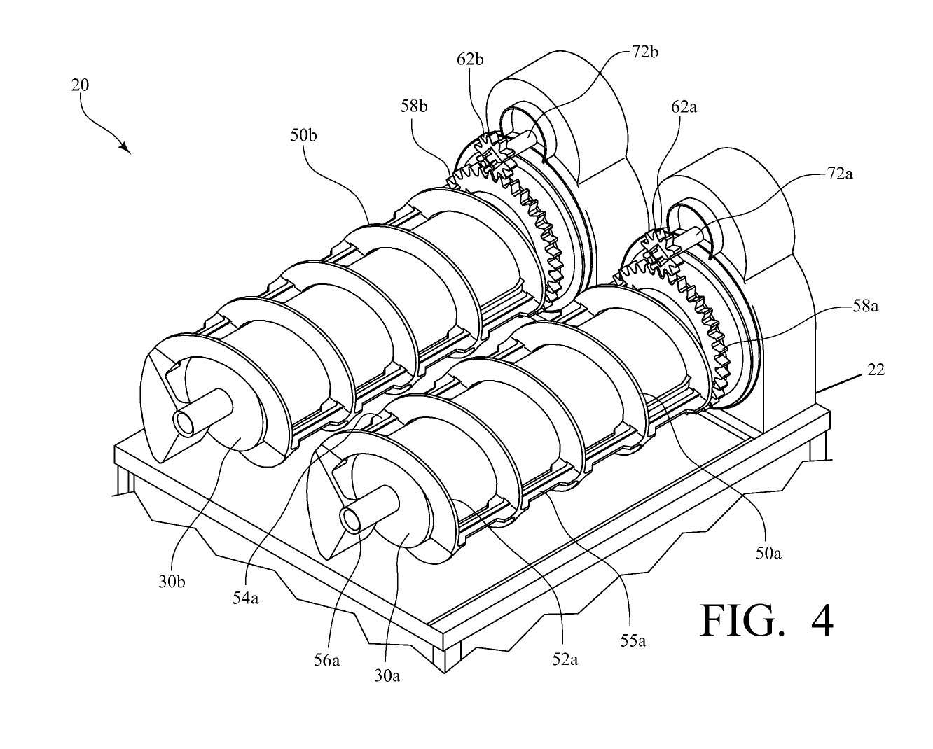

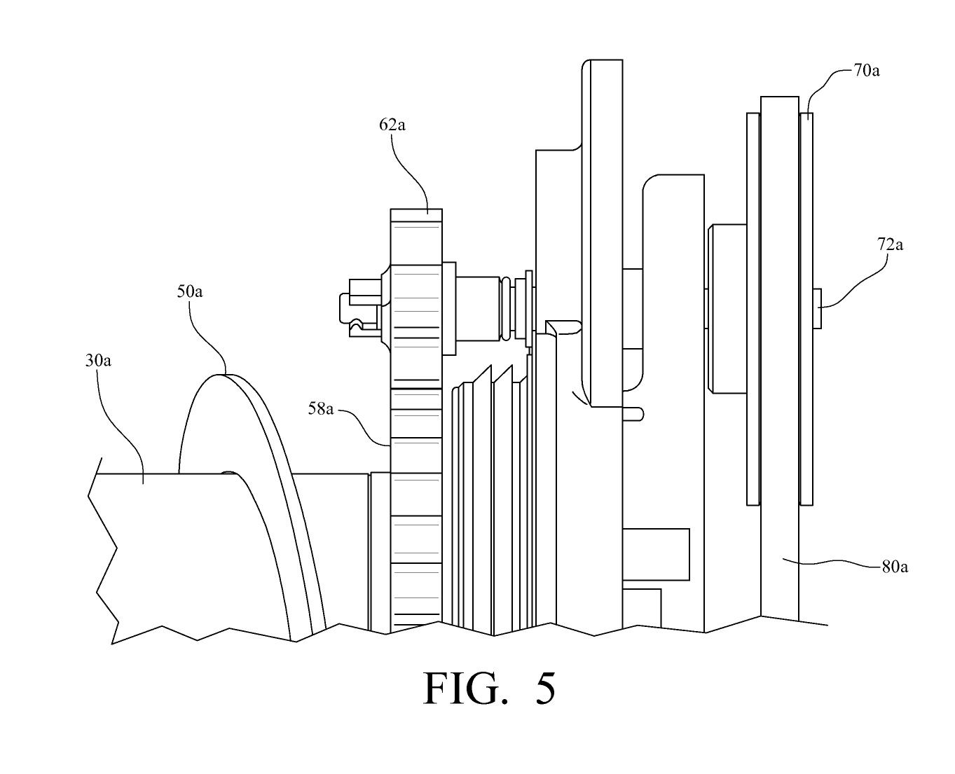

Referring now to FIGS. 4 and 5, in each bowl 24a, 24b, the auger 50a, 50b is driven from the rear, and thus, there is no drive shaft that extends through the respective freezing cylinders 30a, 30b. Specifically, and referring also to FIG. 6, in this exemplary embodiment, each auger 50a, 50b is formed with an integral ring gear 58a, 58b at its second end, which, when assembled, is positioned near the rear of the beverage dispenser 20. The ring gear 58a is engaged by a drive gear 62a, and the other ring gear 58b is similarly engaged by a drive gear 62b. The first drive gear 62a is rotated by a belt and pulley arrangement, and the second drive gear 62b is rotated by a substantially identical belt and pulley arrangement.

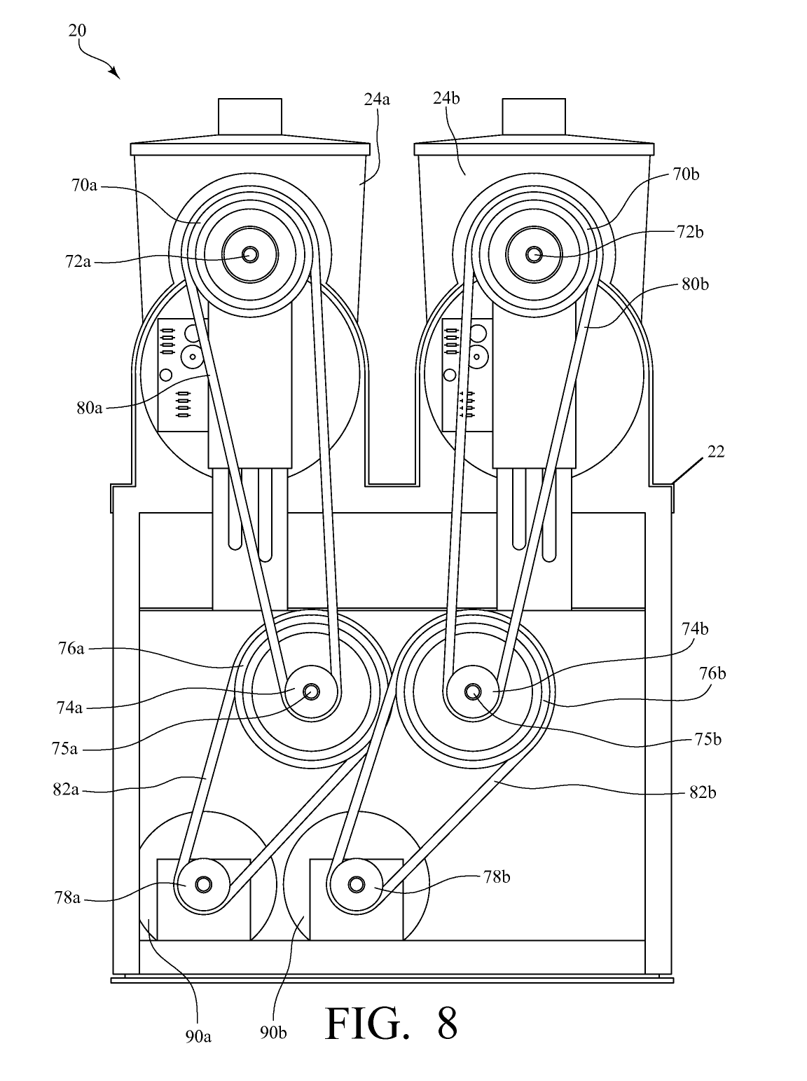

Referring now to FIGS. 4 and 5, along with the rear view of FIG. 8, in this exemplary embodiment, in each belt and pulley arrangement, a first pulley 70a, 70b is mounted to a common shaft 72a, 72b with the respective drive gear 62a, 62b. Each first pulley 70a, 70b is then operably connected to a respective second pulley 74a, 74b by a respective first belt 80a, 80b. In this exemplary embodiment, the ratio of the diameter of each first pulley 70a, 70b to the diameter of each second pulley 74a, 74b is 4:1.7.

Referring still to FIGS. 4 and 5, along with the rear view of FIG. 8, each second pulley 74a, 74b is mounted on another shaft 75a, 75b with a third pulley 76a, 76b, such that each second pulley 74a, 74b rotates with the corresponding third pulley 76a, 76b on the shaft 75a, 75b. The third pulley 76a, 76b is then operably connected to a respective fourth pulley 78a, 78b by a respective second belt 82a, 82b. In this exemplary embodiment, the ratio of the diameter of each third pulley 76a, 76b to the diameter of each fourth pulley 78a, 78b is 5:1.7 The fourth pulley 78a is driven by a motor 90a, which, through the belt and pulley arrangement described above, causes the drive gear 62a to drive the ring gear 58 to rotate the auger 50a. Similarly, the other fourth pulley 78b is driven by a motor 90b, which, through the belt and pulley arrangement described above, causes the drive gear 62b to drive the ring gear 58b to rotate the auger 50b.

In this exemplary embodiment, as a result of the respective ratios described above, each drive gear 62a, 62b is driven and rotates at a speed of 155 RPM when the respective motors 90a, 90b are operating at a speed of 1075 RPM. Furthermore, because there is a gear ratio of 3.5:1 between the respective drive gears 62a, 62b and the ring gears 58a, 58b, the augers 50a, 50b effectively rotate at a speed of 44 RPM.

As mentioned above, in such a construction, there is no drive shaft that extends through the respective freezing cylinders 30a, 30b, and therefore, there is no shaft seal in the lower front portion of the dispenser 20, where it would be continuously submerged in the partially frozen beverage product. Accordingly, the beverage dispenser 20 of the present invention eliminates the attendant problems of leakage at a front shaft seal as is common in prior art constructions.

Furthermore, replacing prior art gear arrangements with belt and pulley arrangements minimizes the problems of heat generation and allows for the use of larger drive motors to better handle the mixing load. Also, maintenance and repair costs are reduced, as most issues with belt and pulley arrangements are more easily resolved as compared to gear arrangements.

As an additional benefit, in such a construction, cleaning of the components is much easier as compared to prior art constructions as each bowl 24a, 24b and each associated auger 50a, 50b can be readily pulled forward and removed from the dispenser as a complete assembly and taken to a wash area for cleaning.

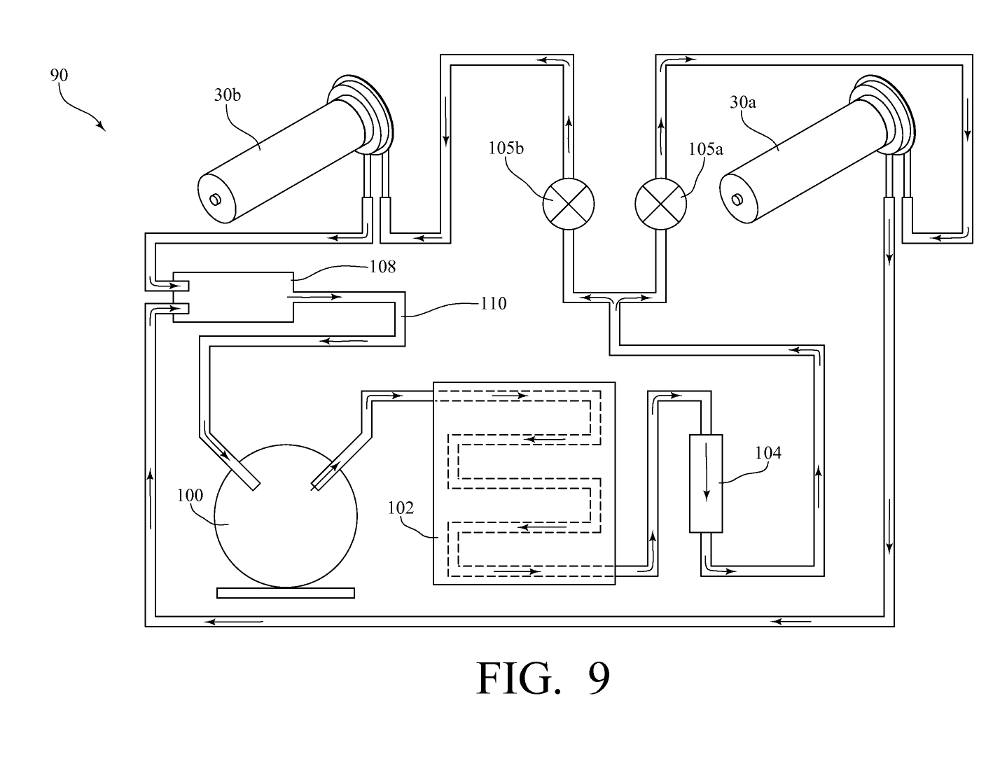

Finally, it should be recognized that an exemplary beverage dispenser made in accordance with the present invention would include a typical cooling system 90 to produce the necessary refrigeration circuit. Specifically, evaporator coils 35 are inside the respective freezing cylinders 30a, 30b (see FIG. 7) and are in fluid communication with certain cooling components housed in a lower portion of the beverage dispenser 20, which is part of the base 22 of the beverage dispenser. For example, as shown in the schematic view of FIG. 9, the cooling components may include a compressor 100, a condenser 102, a filter/dryer 104, an expansion valve 105a, 105b (or other refrigerant control device), a suction accumulator 108, and a suction line 110. As is common in such cooling systems, the compressor 100 compresses the cooling medium, preferably a refrigerant gas such as R404a (a commercially available hydrofluorocarbon refrigerant), to raise the temperature and stored energy of the cooling medium. Therefore, the cooling medium exits the compressor 100 and enters the condenser 102 as a hot, high pressure gas. In the condenser 102, the heat from the pressurization of the cooling medium is dissipated, and the cooling medium reverts to a liquid form, but remains at a high pressure. The cooling medium then passes through a filter drier 104, which is designed to filter out contaminants and dry the cooling medium to prevent ice formation. As it exits the filter drier 104, the cooling medium is separated into two streams, one associated with each freezing cylinder 30a, 30b. In each case, the cooling medium passes through an expansion valve 105a, 105b, each of which serves as a pressure-reducing device and meters the cooling medium into the evaporator coils 35 of the respective freezing cylinders 30a, 30b. Because of the pressure drop, the cooling medium evaporates, absorbing heat as it does so. By the time the cooling medium exits the evaporator coils 35, returning to the compressor 100 through a suction accumulator 108 and associated suction line 110, it again is a cool, low-pressure gas.

One of ordinary skill in the art will also recognize that additional embodiments are possible without departing from the teachings of the present invention. This detailed description, and particularly the specific details of the exemplary embodiment disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A beverage dispenser for partially frozen beverages, comprising:
a base;
a freezing cylinder mounted to the base, said freezing cylinder housing an evaporator;
a bowl for storing a beverage product, with the freezing cylinder extending through a rear wall of the bowl, such that most of the first freezing cylinder is positioned within the bowl when the beverage dispenser is in an assembled state, but, wherein the bowl can be pulled forward and readily disassembled from the freezing cylinder for cleaning;
a cooling system for supplying a cooling medium to the evaporator to cool the beverage product when the beverage dispenser is in the assembled state and the beverage product is stored in the bowl;
a dispenser assembly for dispensing the beverage product from the bowl;
an auger which rotates about the freezing cylinder, the auger including a first end positioned near a front of the beverage dispenser and a second end positioned near a rear of the beverage dispenser, wherein the auger can also be pulled forward and readily disassembled from the freezing cylinder for cleaning, and wherein the auger includes a ring gear positioned at the second end; and
a drive system for driving the ring gear positioned at the second end when the beverage dispenser is in the assembled state, which, in turn, rotates the auger about the freezing cylinder, but without a drive shaft extending through the freezing cylinder.

2. The beverage dispenser as recited in claim 1, wherein the auger is a unitary member.

3. The beverage dispenser as recited in claim 2, wherein the auger is molded from a thermoplastic material.

4. The beverage dispenser as recited in claim 1, wherein the auger includes a helical flange.

5. The beverage dispenser as recited in claim 4, wherein the auger further includes at least two longitudinal ribs that extend the length of the auger.

6. The beverage dispenser as recited in claim 4, wherein, at the first end of the auger, the helical flange terminates in a cylindrical member that defines an internal cavity for receiving a boss extending from a front surface of the freezing cylinder.

7. A beverage dispenser for partially frozen beverages, comprising:
a base;
a first freezing cylinder mounted to the base, said freezing cylinder housing an evaporator;
a first bowl for storing a first beverage product, with the first freezing cylinder extending through a rear wall of the first bowl, such that most of the first freezing cylinder is positioned within the bowl when the beverage dispenser is in an assembled state, but, wherein the first bowl can be pulled forward and readily disassembled from the first freezing cylinder for cleaning;
a first auger which rotates about the first freezing cylinder, the first auger including a first end positioned near a front of the beverage dispenser and a second end positioned near a rear of the beverage dispenser, wherein the first auger can also be pulled forward and readily disassembled from the first freezing cylinder for cleaning, and wherein the first auger includes a first ring gear positioned at the second end;
a first dispenser assembly for dispensing the first beverage product from the first bowl;
a second freezing cylinder mounted to the base, said second freezing cylinder housing an evaporator;
a second bowl for storing a second beverage product, with the second freezing cylinder extending through a rear wall of the second bowl, such that most of the second freezing cylinder is positioned within the second bowl, when the beverage dispenser is in an assembled state, but, wherein the second bowl can be pulled forward and readily disassembled from the second freezing cylinder for cleaning;
a second auger which rotates about the second freezing cylinder, the second auger including a first end positioned near the front of the beverage dispenser and a second end positioned near the rear of the beverage dispenser, wherein the second auger can also be pulled forward and readily disassembled from the second freezing cylinder for cleaning, and wherein the second auger includes a second ring gear positioned at the second end;
a second dispenser assembly for dispensing the second beverage product from the second bowl;
a cooling system for supplying a cooling medium through the evaporators of the first freezing cylinder and the second freezing cylinder to cool the first and second beverage products when the beverage dispenser is in the assembled state, and the first and second beverage products are stored in the first and second bowls; and
a drive system near the rear of the beverage dispenser for rotating the first auger and the second auger, but without a drive shaft extending through the first freezing cylinder or the second freezing cylinder.
